(19) United States
(12) Patent Application Publication
(10) Pub. No.: US 2008/0048102 A1
(43) Pub. Date: Feb. 28, 2008

(54) Optically enhanced multi-spectral detector structure

(75) Inventors: Andrew F. Kurtz, Macedon, NY (US); Barry D. Silverstein, Rochester, NY (US)

Correspondence Address: Andrew J. Anderson, Patent Legal Staff, Eastman Kodak Company, 343 State Street, Rochester, NY, 14650-2201, US

(73) Assignee: Eastman Kodak Company

(21) Appl. No.: 11/508,087

(22) Filed: Aug. 22, 2006

(51) Int. Cl. G01J 3/50; H02N 6/00

(52) U.S. Cl. 250/226; 136/246

(57) ABSTRACT

An integrated optical system and method employs an optical concentrator, a spectral splitting assembly for splitting incident light into multiple beams of light, each with a different nominal spectral bandwidth; and an array of optical detector sites wherein each of the detector sites has a nominal spectral response and wherein the detector sites are spatially arranged to provide an arrangement of said detector sites which are spatially variant relative to said nominal spectral responses. Such a system can be used for purposes such as optical detection and solar collection to provide improved efficiency. Improved efficiency of collection and manufacture are obtainable with using such devices.

### CROSS REFERENCE TO RELATED APPLICATIONS

Reference is made to commonly-assigned co-pending U.S. patent application Ser. No. 10/702,162 by C. Rider, filed Nov. 5, 2003, and entitled “Photovoltaic Device and a Manufacturing Method Thereof”, and to U.S. patent application Ser. No. 10/860,545, filed Jun. 3, 2004, entitled Brightness Enhancement Film using a Linear Arrangement of Light Concentrators, by J. Lee et al., and to U.S. patent application Ser. No. 11/247,509 filed Oct. 10, 2005, entitled Backlight Unit with Linearly Reduced Divergence, by J. Lee, the disclosures of which are incorporated herein.

### FIELD OF THE INVENTION

This invention relates in general to an integrated optical detector assembly designed to receive input light with a wide angular acceptance and multi-spectral band responsiveness. In particular, the invention relates to an optical detector assembly that provides a sheet-like construction, and which may be particularly suitable for solar energy collection.

### BACKGROUND OF THE INVENTION

The detection of optical radiation entails the conversion of photons to electrons in order to create a current. This conversion process is used for sensing, as in the example of an x-ray detector that measures the transmission of light through materials as an indication of density or a photo-diode imager measuring the reflection off of a surface. This photon-generated current could also be used as a source of energy to be stored or harnessed to drive another device. In this case, the detector is considered a photovoltaic cell.

Each of these uses for optical detection often desires the most efficient conversion of optical energy to electrical energy possible. In the case of general detection it is preferred to provide the highest signal to noise property possible for a given amount of light. Likewise it can enable a lower amount of generated light needed to create a quality signal. For a solar panel, it simply means more electrical energy can be harnessed per area of solar cell. Since the cost of solar cells is a function of area, enhanced light conversion efficiency translates into a lower cost per kW. In turn, higher efficiency increases the value of solar energy creation as compared with more conventional fossil fuel sources.

The most common method for producing electricity from light is to use the semi-conducting properties of crystalline silicon. The silicon can be in many forms, single-crystalline, polycrystalline, ribbon and sheet silicon and thin-layer silicon. One of the most important properties to achieve high efficiency is the removal of impurities and defects. This can be achieved by various means; however, the cost of the material tends to be higher as the impurities are removed. Additionally, the base semi-conductors are typically doped with impurities in order to adjust the sensitivity for a particular frequency or wavelength of light. This sensitivity typically is tuned to provide the highest efficiency upon illumination by the solar spectrum. While this is somewhat effective, this approach had demonstrated the best efficiencies of 17.7% by Kyocera Corporation in 2004, with commercially available products achieving 15.7%

One alternative to the crystalline silicon approach is to apply thin film semi-conducting layers to a backing of glass or stainless steel. Materials such as amorphous silicon (a-Si), copper indium diselenide, and cadmium telluride have been used for photovoltaic cells. While these devices are less expensive that the traditional bulk crystalline materials, they also do not absorb as much incident radiation due to the layer thickness, and therefore, have lower efficiency per area. The highest demonstrated efficiency for amorphous silicon devices is currently ˜13% by United Solar Ovonic, of Michigan, which is based on a multilayered structure with three differently doped semiconductor stacked layers to optimize for three portions of the solar spectrum.

Another alternative to crystalline silicon is based on the use of Group III and V materials, typically gallium arsenide (GaAs). The gallium arsenide is doped with a variety of materials such as indium phosphide and germanium. The most efficient demonstrations of this technology occur when the photon energy, defined by the wavelength, matches the semiconductors energy level or “bandgap”. A multi-junction, monolithic solar cell using low-band-gap materials is described in U.S. Pat. No. 6,281,426 by Olson et al. of the Midwest Research Institute. As another example, U.S. Pat. No. 6,252,287 by Kurtz et al. describes a high efficiency heterojunction photovoltaic cells with using InGaAsN/GaAs based structures. A triple layer structure of this type was shown to deliver 37.3% efficiency in 2004 by Spectrolab Inc. of Sylmar Calif. The materials and processes utilized to achieve this efficiency are sufficiently expensive, that large area devices may not be economically practical. In some cases these devices are combined with an optical concentrator to yield overall high electrical conversion per sunlit area.

Dr. Roland Winston of the University of Chicago first developed non-imaging optical concentrators in the 1970's, specifically to further the progress of solar collection. In particular, it was shown that maximal light concentration was generally not provided by a classical imaging optical system, but rather by an optical system that neglected imaging and image quality in favor of maximizing power density. The classical non-imaging design, which is referred to as a compound parabolic concentrator (CPC), is a reflector with a fairly wide acceptance angle (˜±30°) and a complex shape. The light concentration, which is basically the area of the input aperture divided by the area of the output aperture, can be very high (C>10,000). This class of devices is described in prior art patents U.S. Pat. No. 3,923,381 and U.S. Pat. No. 4,003,638, both by Winston. Another early prior art patent, U.S. Pat. No. 4,045,246 by Mlavsky et al., describes an apparatus in which a non-imaging concentrator and a solar cell (such as a photovoltaic cell) are used in combination.

Optical concentrators for traditional photovoltaic panels have also been fabricated utilizing fresnel lenses or shaped mirrors to increase the effective area of collection. Often these systems are done with a large collection area onto a single cell. Other systems utilize an array of cells. For example, U.S. Pat. No. 6,717,045 by Chen, describes a photovoltaic array module design with a three step concentration method. Accordingly, a compound parabolic concentrator (CPC) is mounted under a first concentrating fresnel lens that pre-concentrates the light. The final step of concentration occurs by using a lens at the base of the CPC. While this may be very efficient it does not provide for an inexpensive web or sheet based method of mass-producing solar arrays.

Similarly, U.S. Pat. No. 6,903,261 by Habraken et al., describes a solar concentrator that uses a fresnel lens for pre-concentration followed by a linear array of reflectors to further concentrate the light. While this concept particularly offers potential improvements in illumination uniformity to the receivers (detectors), the design lacks specific features useful to thin film type solar cells specifically, or for solar cells with a limited spectral bandwidth, more generally.

While most solar cells to date have been rigid in form, there are numerous efforts underway around the world to create flexible solar cell structures. In the European Union, a research project called H-Alpha Solar (H-AS) is making very thin solar structures using 1-micron polymorphous silicon deposited at high pressures and temperatures. They have demonstrated efficiencies of about 7%. This solar cell is fabricated on a substrate carrier of aluminum foil to handle the heat and is subsequently moved to a plastic backing followed by a plastic overlayer for protection. While this process lends itself to continuous web production, however, higher efficiency is still desirable.

There are many different candidate technologies being developed as the potential thin film solar cell of the future. To begin with, there are a variety of silicon-based cells, using crystalline thin films (deposited on glass), amorphous silicon films (a-Si), or nano-crystalline silicon thin films (nc-Si). Tandem or multi-layer cells, combining a top layer of amorphous silicon (which has a good visible response) and an inner nano-crystalline (or quantum dot) layer (which has a good infrared response) can be fabricated on glass or on poly-ethylene-terephthalate (PET) to provide an overall thin film device with a wide spectral response. Molecular solar cells are another potential candidate for a new generation of thin film solar cells that are based on nano-structured composites of molecular components or hybrid molecule/semiconductors. There are at least three types of these solar cells, the dye sensitized nano-crystalline thin film (Gratzel solar cell), the organic polymer cell, and a nanoparticle/organic polymer composite solar cell. However, presently the efficiency of these low cost cells is still low and a significant increase is needed. To develop a highly efficient cell, many fundamental challenges in nano-materials fabrication, molecular synthesis, charge separation and transport likely need to be solved.

The so-called Gratzel cell was developed by Michael Gratzel, who is a professor of chemistry at the Institute of Physical Chemistry of the Swiss Federal Institute of Technology. The Gratzel cell is described in U.S. Pat. No. 4,927,721 and U.S. Pat. No. 6,245,988, both by Gratzel et al. In this device, particles of titanium dioxide are coated with a photosensitive dye (a metalorganic dye), and suspended between two electrodes in a solution containing iodine ions. When this dye is exposed to light energy, some of its electrons jump on to the titanium dioxide particles, which then are attracted to one of the electrodes. At the same time, the iodine ions transport electrons back from the other electrode to replenish the dye particles. This creates a flow of electrons around the circuit. This cell may only be slightly less efficient than a silicon-based cell, but as its principal ingredients are inexpensive, and as it can be manufactured by screen-printing, it represents a potentially affordable technology for developing countries. However, the dyes in these cells can suffer from degradation under heat and UV light, and the cell casing is difficult to seal due to the solvents used in the assembly process.

There are a wide variety of nanoparticle/organic polymer composite solar cells under development, including a cell being jointly developed New Mexico State University (NMSU) and Wake Forest University, which comprises a combination of an organic polymer and carbon bucky-balls (fullerenes) that is expected to be both relatively inexpensive as well as flexible, and could even be applied like paint. As another example, Paul Alivisatos at the University of California, Berkeley, is developing a hybrid solar cell is actually comprised of tiny (7 nm wide and 60 nm long) nanorods dispersed in an organic polymer or plastic (P3HT: poly-(3-hexylthiophene)). The nanorods act like wires. When they absorb light of a specific wavelength, they generate an electron plus an electron hole—a vacancy in the crystal that moves around just like an electron. The electron travels the length of the rod until it is collected by the aluminum electrode. The hole is transferred to the plastic, which is known as a hole-carrier, and conveyed to the electrode, creating a current. A layer only 200 nanometers thick is sandwiched between electrodes, and can produce ˜0.7 volts. It is anticipated that the electrode layers and nanorod/polymer layers could be applied in separate coats, making production fairly easy. Another approach combining nano-particles and organics is being developed by Ted Sargent at the University of Toronto (Canada). In this case, lead sulfide (PbS) quantum dot nano-crystals, a mere 1-4 nm in diameter are suspended in a semi-conducting plastic (MEH-PPV), which has a visible spectrum absorptance, sensitizing the polymer for absorption in the infrared. By controlling the size of the nanocrystals, or quantum dots, the scientists can tune the solar cells to absorb IR light at peak wavelengths of 980, 1200, and 1355 nm. These small sizes enable the particles to remain dispersed in normal solvents that can be coated by methods such as ink jet or paint. Companies specializing in nano-structure enabled devices, such as Nanosys of Palo Alto, Calif., and Konarka Technologies of Lowell, Mass., are also participating in this area.

As solar cells are made thinner, either to reduce the quantity and cost of silicon employed, or to enable thin film solar detection structures, the maximum thickness of the absorbing layers may be limited. To compensate for this, solar cells have been developed with surface textures that improve efficiency by trapping the light within the absorbing layer. For example, a diffraction grating structure or a sub-wavelength structure can be embossed or otherwise patterned on an upper (light incident) surface. Exemplary devices of this sort are described in U.S. Pat. No. 6,147,297 (Wettling et al.) and U.S. Pat. No. 6,858,462 (Zaidi et al.). As the spectral response of the thin film solar cells is generally limited (for example, to ˜200-400 nm bandwidth) and may only span a portion of the visible spectrum, the tandem or multi-layer cell is being developed as an approach to expand the range of response. For example, a tandem solar cell is described in U.S. Pat. No. 6,566,159 (Sawada et al.).

Relative to the present invention, it is recognized that inexpensive sheet micro-optical structures have been demonstrated for applications within the display industry. In many cases, these structures can be manufactured by web or roll coating or extrusion processes, coupled with pattern embossing. In the liquid crystal display (LCD) industry it is common to use brightness enhancing films to convert the substantially lambertian light from the backlight to a more angularly controlled distribution that the display can best utilize. To some extent, these structures can be thought of as photovoltaic cells in reverse. Examples of brightness enhancement methods include:
U.S. Pat. No. 5,592,332 (Nishio et al.) discloses the use of two crossed lenticular lens surfaces for adjusting the angular range of light in an LCD display apparatus.
U.S. Pat. No. 5,611,611 (Ogino et al.) discloses a rear projection display using a combination of fresnel and lenticular lens sheets for obtaining the desired light divergence and luminance.
U.S. Pat. No. 6,111,696 (Allen et al.) discloses a brightness enhancement film for a display or lighting fixture. The surface of the optical film facing the illumination source is smooth, while the opposite surface has a series of structures, such as triangular prisms, for redirecting the illumination angle. This film refracts off-axis light to provide a degree of correction for directing light at narrower angles. However, this film design works best for redirecting off-axis light, as incident light that is normal to the film surface may be reflected back toward the source, rather than transmitted.
U.S. Pat. No. 5,629,784 (Abileah et al.) discloses various embodiments in which a prism sheet is employed for enhancing brightness, contrast ratio, and color uniformity of an LCD display of the reflective type. For example, Abileah ‘784 describes a brightness enhancement film similar to that of the Allen '696, but with its structured surface facing the source of reflected light for providing improved luminance as well as reduced ambient light effects. Because this component is used with a reflective imaging device, the prism sheet is placed between the viewer and the LCD surface, rather than in the position used for transmissive LCD systems (that is, between the light source and the LCD).
U.S. Pat. No. 6,425,675 to Onishi et al., describes an illumination apparatus in which a light output plate has multiple curved facet projections with their respective tips held in tight contact with the light exit surface of a light guide member and using a process to improve bonding power and avoid embedment of projections.
U.S. Patent Application Publication No. 2001/0053075 (Parker et al.) discloses various types of surface structures used in light redirection films for LCD displays, including prisms and other structures.
U.S. Pat. No. 5,887,964 (Higuchi et al.) discloses a transparent prism sheet having extended prism structures along each surface for improved backlight propagation and luminance in an LCD display. As is noted with respect to the Allen '696 patent mentioned above, much of the on-axis light is reflected rather than transmitted with this arrangement. Relative to the light source, the orientation of the prism sheet in this patent is reversed from that used in the Allen '696 disclosure. The arrangement shown in the Higuchi '964 disclosure is usable only for small, hand-held displays and does not use a Lambertian light source.
U.S. Pat. No. 5,396,350 (Beeson et al.) discloses a backlight apparatus with light recycling features, employing an array of micro-prisms in contact with a light source for light redirection in illumination apparatus where heat may be a problem and where a relatively non-uniform light output is acceptable. Beeson '350 also uses an array of micro-prisms in combination with an array of micro-lenses, where a given micro-prism and a corresponding micro-lenslet work in tandem to provide generally collimated output illumination light.
Commonly assigned co-pending U.S. patent application Ser. No. 10/860,545 by J. Lee et al. discloses using a plurality longitudinal light collecting structures comprised of an output aperture and an input aperture, where the output aperture is bigger than the input. Also, where the sidewalls are formed from a pair of curved surfaces extending from the output aperture to the input aperture and the curves approximate a parabolic curvature. This provides an inexpensive and effective method of controlling the angular response for display and demonstrates the type of structure that would be useful and inexpensive as a concentrator for use in a web based solar panel solution.

While the optical methods and technologies used in thin film micro-optics in the display industry might have considerable value in the design of improved solar cells, there have been very few efforts in that direction to date. The solar concentrator demonstrated in U.S. Pat. No. 6,804,062 by Atwater et al. shows a partial recognition of the potential benefits of combining these technologies. In particular, this patent describes a combination of fresnel lenses and solid immersion lenses fabricated into an array pattern from silicone rubber, with a lens pattern that matches the array of corresponding photovoltaic cells. While this does offer a novel means of fabricating the concentrating optics, it does not address the spectral limitations solar cells, and it specifically does not consider configurations employing multiple bandgap cell structures. Furthermore, Atwater '062 does not utilize the considerable knowledge and experience in conventional molded (or roll coated or extruded) optics to provide a low cost web based solar cell.

As another approach, US Application 2004/0084077 by Aylaian describes a three-dimensional array structure for solar collection. In this application, a solar panel with a multi-layer patterned structure is proposed wherein gaps between the different layers of photovoltaic cells are used to transmit direct or reflected light to the various layers of photovoltaic cells. Depending on materials choices, different layers may have different spectral responses. As a result, the incident light has an increased chance of interacting with a detector with a photo-electric response which is better optimized to the given incident wavelength of the light. In effect, the multiple reflections create a cavity for light confinement and absorption. While this approach potentially increases the efficiency of a solar panel, the design relies on iterative reflections with a substantial space loss (low fill factor) to provide the multi-spectral conversion. This approach does not recognize the possible improvements that could be obtained using optical elements (lenses, filters, etc.) to direct the incident light to a given detector with the appropriate spectral response. Nor does this approach recognize the potential to apply the principles of replicated sheet polymer optics to create inexpensive thin film solar cells. U.S. Pat. No. 6,333,458 by Forrest et al., also provides for a thin film solar cell employing a solar concentrator and a reflective cavity to trap light within a photo-conversion layer. As the spectral response of the photo-conversion layer may be poor for some wavelengths, that light may leak out of a concentrator (which typically has a wide angular acceptance) before it is absorbed.

Thus it can be seen there is a considerable desire for developing the means to create a flexible low cost web based means for a high efficiency solar or detection cell. Although notable progress is being made on many fronts, opportunities remain to improve upon the design and performance of solar cells generally, and in particular, for light efficient, mass-producible solar cells manufactured using thin film or web coating type technologies. It is notable that the efforts to date seem focused on the materials properties, relative to light absorption, charge transport, and cell manufacturing problems, but that relatively little attention has been given towards having an improved optical design that would enhance efficiency, particularly for thin film based solar cells. Specifically, it is likely that unique micro-structured optical films and unique flexible or thin film solar cells can be combined synergistically to create devices with enhanced performance.

### SUMMARY OF THE INVENTION

An integrated optical system and method employs:

a) an optical concentrator for receiving and concentrating incident light;

b) a spectral splitting assembly for splitting said incident light into multiple beams of light, each with a different nominal spectral bandwidth; and

c) an array of optical detector sites wherein each of said detector sites has a nominal spectral response and wherein said detector sites are spatially arranged to provide an arrangement of said detector sites which are spatially variant relative to said nominal spectral responses;

wherein each of said detector sites nominally receives one of said multiple beams of light, such that the spectral bandwidths of light which are directed to said detector sites nominally match said nominal spectral responses of said detector sites; and

wherein said optical concentrator, said spectral splitting assembly, and said array of optical detector sites are replicated in an array-like fashion to form said integrated optical detector assembly. The optical concentrator, spectral splitting assembly, and array of optical detector sites are replicated in an array-like fashion to form the integrated optical detector assembly. Such a system can be used for purposes such as optical detection and solar collection to provide improved efficiency.

Improved efficiency of collection and manufacture are obtainable with using such devices.

### BRIEF DESCRIPTION OF THE DRAWINGS

FIG. 1 is a perspective view of the general concept of an integrated optical detector of the present invention that further depicts the sun and solar collection by the device.

FIG. 2 is a cross sectional view of a first embodiment for an integrated optical detector of the present invention.

FIGS. 3a and 3b are cross sectional views of alternate embodiments for an integrated optical detector of the present invention.

FIGS. 4a, 4b, 4c, 4d are cross sectional views that depict the construction and use of the concentrators and the micro-prism assembly as used in the integrated optical detector of the present invention.

FIG. 4e is a cross sectional view of a blazed diffraction grating.

FIGS. 5a and 5c are cross sectional view of alternate embodiments for an integrated optical detector of the present invention.

FIG. 5b is a cross sectional view that depicts the construction of a micro-prism assembly.

FIG. 6 is a cross sectional view of an alternate embodiment for an integrated optical detector of the present invention.

FIGS. 7a and 7b are cross sectional view of alternate embodiments for an integrated optical detector of the present invention.

FIG. 8a is a perspective view of an alternate embodiment for an integrated optical detector of the present invention.

FIG. 8b is a cross-sectional view of an alternate embodiment for an integrated optical detector of the present invention.

### DETAILED DESCRIPTION OF THE INVENTION

Classical solar energy conversion uses concentrators, such as CPCs, to maximize the solar power density into the smallest area. In the case of photovoltaic conversion, the historical limits of semiconductor wafer size and cost motivated a maximization of solar energy conversion per unit area. Additionally, as the current produced by photovoltaic cells is proportional to the irradiation incident onto the cells, more light will increase the electrical output. In the case of photo thermal conversion, such as applying solar energy to heat water flowing in a pipe, maximizing solar energy density minimizes the thermal mass and thermal dissipation. Concentrators, such as CPCs, also have a significant additional advantage that the wide acceptance angle, for example ±40°, enabled an efficient solar light conversion that does not require solar tracking. However, in the future, as large area solar cells become increasingly economical, maximum solar concentration may become a less compelling design motivation for solar power systems. Indeed an inexpensive thin film sheet solar cell can operate without any concentrator at all, thereby saving the associated costs. Rather, in the case of thin film solar cells, the desired light concentration provided by a concentrator may be motivated by secondary solar cell design factors, such as threshold effects, uniformity effects, charge transfer efficiencies, noise sources, etc., which may suggest alternate optimizations.

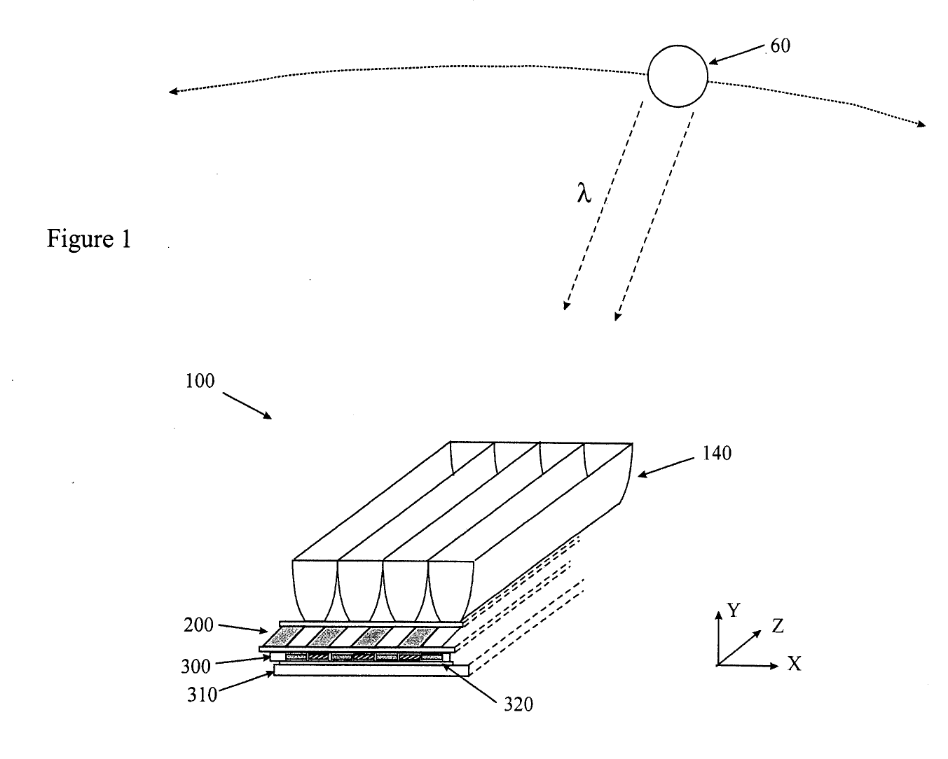

The basic concept for an integrated solar energy conversion of the present invention is depicted in FIG. 1. As the sun 60 traverses the sky from dawn to dusk, east to west, the narrow cone of light that is incident on integrated optical detector 100 is swept through a wide angular range, which is greater than ±60° (depending on terrain). In practice, useful solar collection occurs over a smaller angular range, which is typically ±30-35°, but may be as much as ±45°. As the sun 60, is 863,700 miles in diameter and 93 Million miles distant from the Earth on average, the cone of light incident at the Earth is a very narrow 0.266° (half angle). This angle, which corresponds to a numerical aperture (NA) of ˜0.0046, is effectively equivalent to collimated light. Solar radiation comprises this essentially collimated direct beam radiation, as well as a diffuse component. The diffuse component is typically small, unless significant cloud cover is present.

The incident solar radiation (insolation) is to first order, considered as equivalent to the radiation of a 5900 K black body source, with a spectrum spanning the range of 0.2-3.0 μm. The great majority of the radiation falls within a narrower range of wavelengths spanning the visible and near infrared spectrums (˜0.3-1.3 μm). Atmospheric gases, such as water vapor, carbon dioxide, ozone, nitrous oxide, and carbon monoxide, preferentially absorb portions of the solar spectrum. Water vapor is the major absorber, with absorption bands in the near-IR around 720, 820, and 940 nm, and further out (1.18, 1.38, 1.9 μm) in the infrared as well. The second most important absorber in the UV-visible-Near-IR part of the spectrum is ozone. Ozone has several absorption bands, including bands between 310-350 nm (Huggins band) and 450-850 nm (Chappuis bands). Some absorption bands are weak (relatively high transmission) while others are strong (˜0.74, ˜1.14, ˜1.38) and reduce ˜75% (or more) of the radiation in the relevant spectral range.

The solar collection system of the present invention is principally an integrated optical detector assembly 100 comprising an optical concentrator array 140, a spectral splitting assembly (micro-prism array 200), a photo-receptive detector array 300, a circuit 320, and a detector substrate 310. The concentrator array 140 can comprise a series of one-dimensional, trough-like cylindrical (or anamorphic) concentrators, which are elongate in the Z-direction, as shown in FIG. 1. Accordingly, light is collected by a given concentrator within concentrator array 140, and then nominally directed through the corresponding micro-prism elements to the corresponding detector elements. The micro-prisms of prism array 200 are provide with spectral discrimination means to split or re-direct the incident light into a number of beams nominally comprising light of a given spectral bandwidth Δλ. For example, the incident light might be split into three spectral bands, a UV-blue band Δλ₁, a green-red band Δλ₂, and an IR band Δλ₃. Micro-prism array 200 could provide this spectral splitting via the use of dichroic thin film optical filters, although other spectral splitting means can be employed. The detector array 300 would then comprise a set of light detection pixels (or sites), where the pixel which nominally receives light of a given spectral band Δλ is nominally optimized (or tuned or sensitized) for efficient energy conversion for that band. It is assumed that a pattern of spectrally tuned photo-responsive pixels is fabricated within a solar cell structure, to form the solar detector array 300. In this way, the demands on the breadth of the spectral response of the solar cell might be reduced on a localized (spatially patterned) basis. As solar cell losses primarily arise from the mismatch between the large range of photon energies in the incident spectrum and the materials limitation in providing band gaps to match this continuum of energy levels, the use of spatially patterned spectrally variant detector sites may provide key advantages. Optical detector assembly 100, which is principally conceived of for solar energy conversion, is preferably a thin film solar device, in which concentrator array 140, spectral splitting assembly 200, and detector array 300 are each film or sheet structures that are integrated together to form a sheet solar panel assembly.

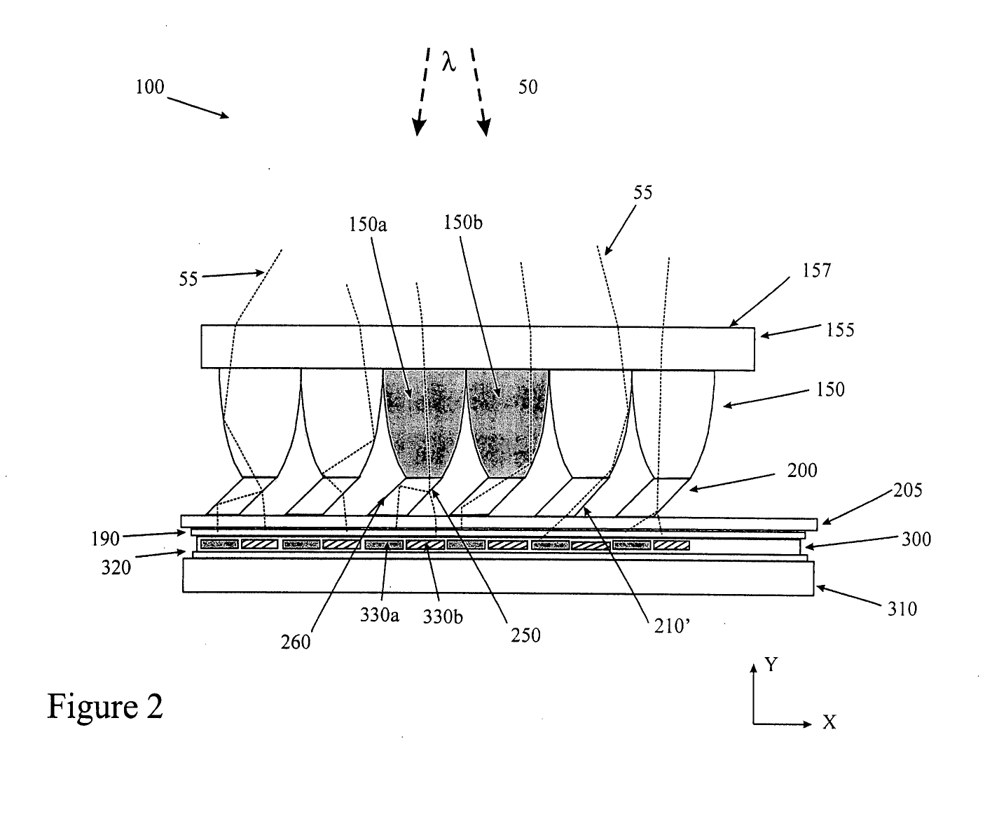

The primary structural elements of the solar collector 100 are shown in FIG. 2 in greater detail. The concentrator array (140) comprises a series of light concentrators 150 formed on a concentrator substrate 155. Concentrators 150 and concentrator substrates 155 are nominally manufactured from a transparent optical plastic material, such that light enters the device through input surface 157 and propagates into a given concentrator, where it can reflect by total internal reflection (TIR) at an outer surface of the concentrator (at the dielectric/air interface), as depicted by some of the raypaths 55. For clarity, two exemplary concentrator elements, optical concentrators 150a and 150b are identified and shaded. Incident light 50 (shown in part by a few representative raypaths 55) is directed by a concentrator 150 through a micro-prism 210 and to detector pixels (such as 330a and 330b). The incident light encounters a splitting surface of micro-prism 200 that has a spectral filter 250 that separates the incident light into two spectral bands. One spectral band is then directed through to detector pixel (or site) 330a, and the other band passes to pixel 330b. Considering again the anamorphic structure of solar conversion system 100 of FIG. 1, then these solar collection pixels 330 are basically a set of elongate (in Z) parallel detectors arrayed in a planar film in the XZ plane (see FIG. 1) beneath each concentrator 150. Thus the direction of spectral splitting is oriented nominally parallel with the direction of solar motion (east-west), while the pattern of elongate detectors is oriented in a nominally orthogonal fashion to the direction of solar motion. Solar pixels 330 are connected to circuitry 320, to access (collect & transfer) the solar photo-generated electrons.

Although the photo-sites are depicted as a series of adjacent discrete detector sites 330a,b,c, these detector sites could also be provided in such close proximity to effectively become a single site with a spectral response (spectral sensitivity) that is spatially variant in a one-dimensional cross-section across a width of the detector site. In that case, larger detector sites 330 could be formed via a variable doping to create photo-sites with either a stepwise or gradient spatially variable spectral response. Depending on the design constraints and manufacturing processes used to form the detector sites and the associated circuitry, one approach may be favored over the other.

The rhomboid shaped micro-prisms 210 of micro-prism array 200 are designed in a tilted manner with respect to the centerline axis of concentrators 150. As a result, normally incident light interacts with the inward sloping prism surface having spectral filter 250, and is spectrally split, with the light transmitted through filter 250 being intended for detector site 330b. Light that reflects from filter 250 can then reflect from the outward-sloped prism surface (reflecting surface 260), to then be directed onto detector site 330a. The micro-prisms 210 are tilted and elongated so that most of the incident light will interact with the spectral splitting filter 210 at least once before reaching the detector sites 330. Although reflecting surface 260 could be coated with a high reflectivity dielectric or metallic coating, with this prism geometry, total internal reflections (TIR) should suffice.

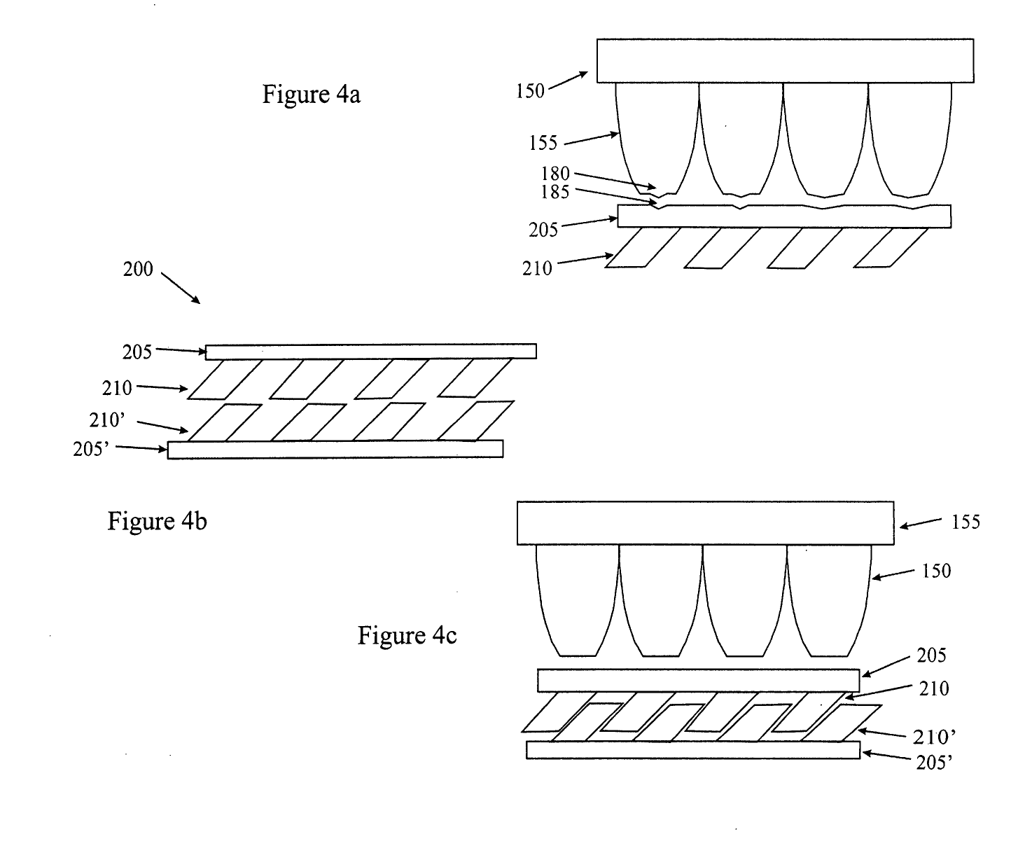

As previously stated, concentrators 150 are shown in FIGS. 1 and 2 (and generally in the other figures as well) as solid dielectric devices. Alternately, the concentrators 150 can be hollow, comprising an air-space within a shell reflector, such that light travels through air within the concentrator, and then reflects off the outer wall, as generally depicted in FIG. 4d. However, this requires the inner surfaces 158 of the wall structure to be provided with a reflecting interface, such as a metallic aluminum mirror coating. Additionally, the incident angles of the light then progressing into the prisms 210 will be higher than in the case when concentrator 150 is a solid dielectric, which can reduce the light coupling efficiency. Larger acceptance angles and higher concentrations are also generally achieved more readily with solid dielectric concentrators than with hollow ones.

The non-imaging concentrator structures, of which the CPC is the best recognized, are then useful in part for this concept in that they create space for other optics. In particular, by concentrating the light incident to a CPC into a smaller size (such as a cross-sectional width ˜2-5× smaller), space then becomes available for both the micro-prism elements and the spatially patterned detector sites to be provided underneath the concentrators 150. In other words, the optical fill factor for the incident light at concentrator substrate 155 is nominally 100%, but the optical fill factor at the output end of the concentrators 150 is much smaller (for example, ˜30%).

As an example, a non-imaging concentrator design, known as a θin/θout concentrator device could be utilized, where the nominal maximum input angle is θin ˜30° and the nominal maximum output angle is θout ˜45°. An exemplary concentrator 150 can have an input width of ˜30 μm, an output width of ˜11 μm, and a length of ˜44 μm. The light concentration would likely be fairly low (C˜1-10). In the preferred circumstance that concentrators 150 are solid dielectric devices, concentrators 150 and prisms 210 are assumed to nominally have the same index of refraction, and indeed are nominally made from the same materials.

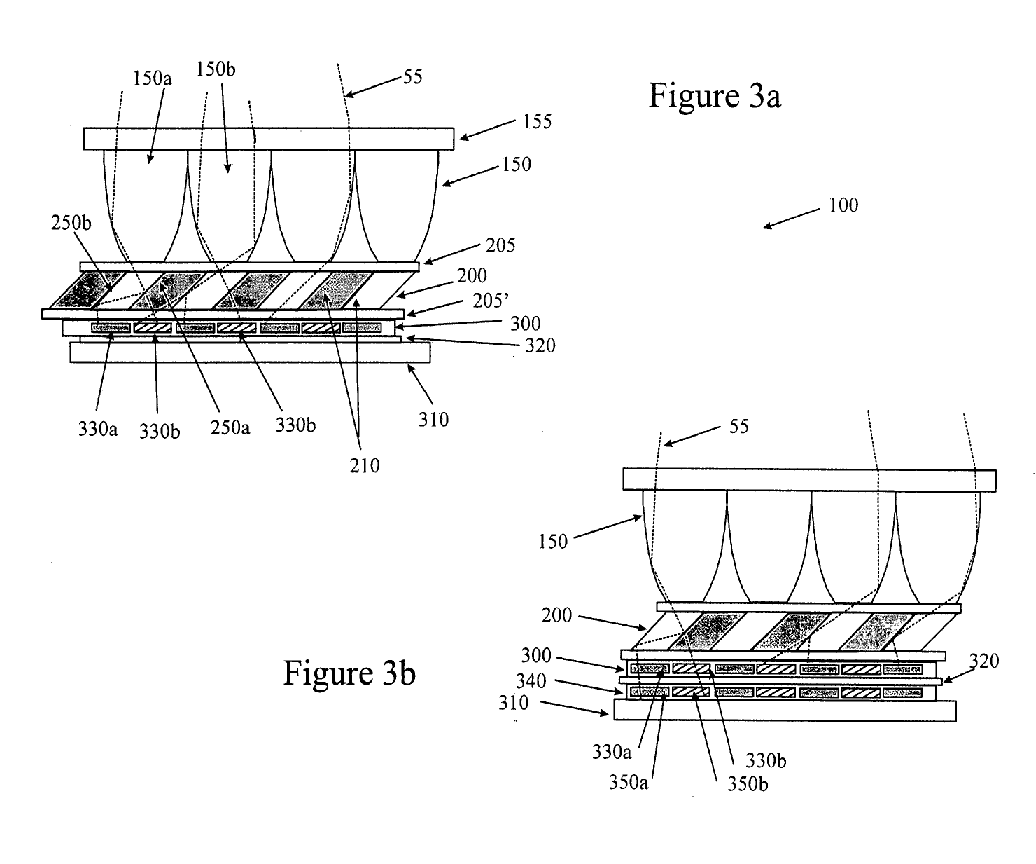

While the design concept for solar collection assembly 100 shown in FIG. 2 appears simple, there are several issues of concern, including the effectiveness of the color splitting at the inward prism surface. In particular, a fair portion of the light incident on this surface will reflect by TIR, due to the angles and the glass to air interface. To counter this, the micro-prism array 200 can be constructed using imbedded prisms, as shown in FIG. 3a. An optical adhesive or gel (not shown) could be used to hold adjacent prism surfaces together. In this illustration, alternate micro-prisms 210 are shaded for clarity. The inward prism surface of a micro-prism proximal to a concentrator 150 can be coated with a spectral filter 250a, which transmits a bandwidth Δλ₁ and reflects a bandwidth Δλ₂. The outward prism surface can be coated with a spectral filter 250b which transmits a bandwidth Δλ₁ and reflects a bandwidth Δλ₂. In this way, detector site 330a would nominally receive Δλ₂ light while detector site 330b would nominally receive Δλ₁ light. Thus spectral filters 250a and 250b can be identical. Spectral filters 250 can be dichroic coating, with a traditional multi-layer thin film dielectric stack structure. Spectral filters 250 can also be sub-wavelength optical structures, which comprises an area with a pattern of sub-micron or indentations and elevations that are formed into a surface. For example, a nano-optical bandpass filter, with a high visible wavelength transmission and a high infrared rejection (reflection), similar to the Subwave IRCF filter offered by NanoOpto Corporation of Somerset N.J., could be used. However, the design of a spectral filter based on sub-wavelength structures may be limited by the refractive index of an adhesive holding imbedded prisms 210 together.

As a further variation, FIG. 3b depicts a solar collection assembly 100 in which there is a first photo receptive detector array 300 and second detector array 340, which is located in a parallel offset plane from the first array. Second detector array has detector (photon-conversion) sites 350. For example, detector sites 350a and 350b can be located within a second planar film directly underneath detector sites 330a and 330b. Thus, while a detector site 330a may receive incident light of spectral bandwidth Δλ₂, detector site 330a may only be responsive to a subset (Δλ₂ₐ) of this bandwidth. The spectral difference, Δλ_{2b}=Δλ₂−Δλ₂ₐ, could be transmitted through to detector site 350a, where it could then be absorbed. In this way, the light collected by one concentrator 150 can split into four spectral bands for enhanced photo-conversion. The solar collection system 100 of FIG. 3b can be thought of as a multi-layer or tandem solar cell that is optically enhanced by the synergistic combination of the concentrators (150), the spectral splitting structures (micro-prisms 210 and spectral filters 250), and the spatial patterning of spectrally responsive (or sensitized) detector sites on at least one plane (or in at least one detector array).

Detector array 300 is preferentially formed as a patterned film, for example using roll-coating or printing processes. Likewise, circuit 320 could be patterned, using coating or printing processes onto its own substrate, or directly onto the film comprising the detector array. Both the spectral splitter (micro-prism array 200) and the concentrator array 140 could be embossed or replication molded into a sheet or film. The spectral filter assembly may then need separate processing to apply reflectance or spectral splitting optical coatings. These various sheet or film structures, along with other components such as substrate 310, any blocking filters or barrier layers, etc., could then be combined to form an overall solar conversion assembly 100 by using lamination, adhesive film interlayers, and other sheet manufacturing processes.

The illustrations of FIGS. 4a, 4b, and 4c depict aspects of how concentrator array 140 and micro-prism array 200 can be constructed and assembled. In FIG. 4a, the issues of coupling concentrators 150 to the prisms or a prism substrate 205 are considered. Light concentration films or sheets must be optically coupled to the corresponding micro-prisms in some way. Optical coupling can be provided using a layer of optical adhesive or other bonding agent (not shown) that has an index of refraction closely matched to the index of refraction n of both the concentrators 150 and the prisms 210. The optical adhesive also helps to compensate for dimensional tolerance errors in the fabrication of these components. The concentrators 150 and prisms 210 or prism substrates 205 can be provided with matching first and second registration features 180 and 185. These features can be used to help these components self align. Additionally, these features can help these components maintain alignment (registration) as the assembly 100 endures both high thermal loads and thermal cycling, either directly from solar exposure, or indirectly from ambient environmental changes. FIG. 4b illustrates how micro-prism array 200 can be assembled from two nominally identical prism arrays of rhomboid prisms, the first comprising prisms 210 and prism substrate 205, and the second comprising prisms 210′ and substrate 205′. An optical adhesive or gel (not shown) would hold the adjacent prism surfaces together. FIG. 4c then depicts how the concentrators 150 and prism arrays can be assembled to form an overall optical coupling sheet or film assembly, as then used in a solar collection assembly 100, such as depicted in FIG. 3a. It is also noted that the choice of materials used in the designs for concentrators 150, micro-prism assembly 200, detector array 300, and detector substrate 310 may be influenced by thermal considerations. As the temperature of assembly 100 changes, these components may shift relative to each other, effecting the internal alignment, and thus the conversion efficiency. To reduce this risk, materials could be chosen with similar coefficients of thermal expansion, so that alignment is maintained. Alternately, materials could be chosen to effect an athermal design, so that relative motions cancel.

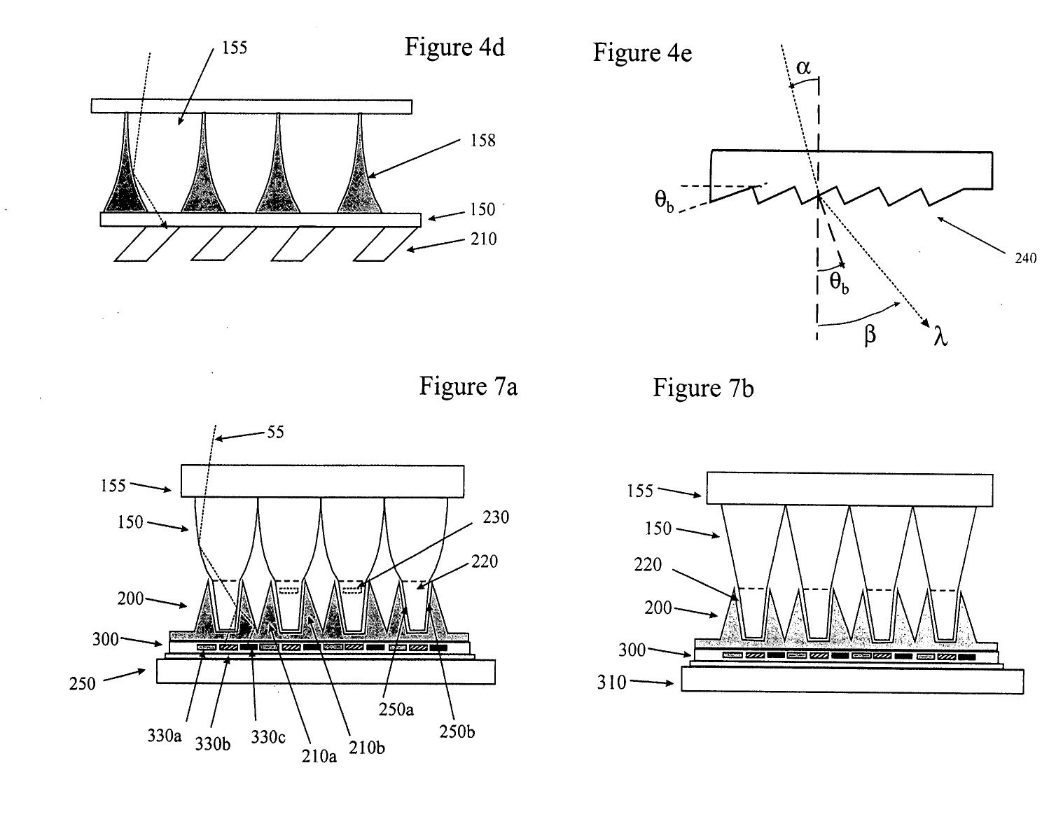

Two alternate constructions for a solar collection assembly 100 with a spatially patterned planar multi-spectral receiver array are depicted in FIG. 5a. In either case, the light of spectral bandwidth Δλ, via a concentrator 150, is directed to a detector site 330a, without first passing through a micro-prism assembly. Detector site 330a then absorbs a spectral bandwidth Δλ₁, while nominally transmitting a spectral bandwidth Δλ-Δλ₁. This light can then reflect off of an underlying micro-prism array 200, to be incident on detector site 330b. Detector site 330b is then intended to absorb this spectral difference bandwidth Δλ-Δλ₁. Prism array 200 can use right angle prisms and operate by TIR as shown on the left of FIG. 5a, or with an external coated surface reflection (260), as shown on the right. An array structure of imbedded right angle micro-prisms 200 can also be provided, as shown in FIG. 5b, where prism substrates 205 and 205′ are assembled together. FIG. 5c then depicts a tandem or multi-layer solar collection assembly 100 using the imbedded prism array structure 200 of FIG. 5b to provide a device with two detector arrays (300 and 340) and four spectrally tuned detector sites (330a, 330b, 350a, and 350b) per concentrator 150. In this case, spectral filters (bandpass/band relection) could be provided at the prism interfaces, and in cascading fashion, separate given spectral bands. For a comparison, in the solar collection assembly 100 of FIG. 3a, the circuit 320 can use copper traces, conductive inks, or other appropriate means. However, the solar collection assemblies 100 of FIGS. 3b, 5a, and 5c require circuit 320 to be light transmissive, which may impose layout or materials (such as ITO) restrictions, although the circuit traces can be routed between the detector sites.

The various prior micro-prism arrays 200, and particularly those for solar collection assemblies 100 of FIGS. 2, 3a, and 3b are somewhat complex structures, which may impart difficulties and extra costs to the replication and assembly processes. The right angle micro-prism arrays of FIG. 5a-c are simpler, but require at least some detector sites 330 to be light transmissive.

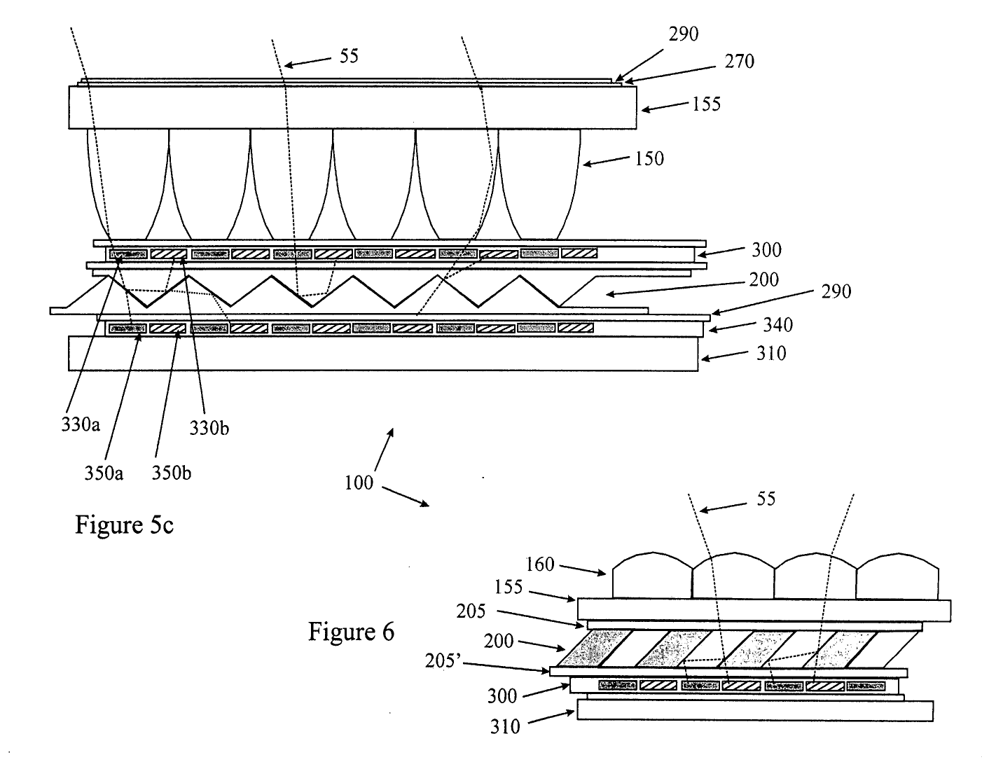

FIG. 7a suggests another alternative that has a simplified micro-prism array 200. In this case, concentrators IS0 couple into integrators 220, which are tapered light guides. Together, the tandem of concentrators 50 and tapered light guide integrators 220 form a combination or two-stage concentrator. These concentrators 150 and integrators 220 likely can be more readily integrally injection molded or replicated using an embossing roller than can the concentrator 150/prism 210 structure of FIG. 2, because of the less extreme shaping. The angular slant or taper of light guide integrators 220 will be balanced between mechanical considerations and an efficiency loss from retro-reflections within the light guides. Each light guide integrator 220 is inset into the micro-prism array 200, between corresponding micro-prisms 210 and 210′, with an intermediate optical adhesive (not shown). The abutting surfaces of the micro-prisms (210) can have spectral filters 250a and 250b respectively. In this case, a spectral band Δλ₁ is transmitted through filter 250a, while a spectral band Δλ₃ is transmitted through filter 250b. These transmitted light beams can then TIR off the external prism surfaces to be directed to the detector sites 330 below. Thus a concentrator 150 has three corresponding detectors sites 330a, 330b, and 330c, nominally located in the planar film structure of photo-receptive detector array 300, which can be tuned to convert light of spectral bands Δλ₁, Δλ₂, and Δλ₃, respectively. While the solar collection assembly 100 does not impose transmission requirements on the photo-cells, and provides simple prism constructions, there is the issue that normally incident light of all wavelengths can fall directly on central detector site 330b. This for example, could happen at noon, or mid-day more generally. To reduce this effect, diffusers 230 could be formed within the light guides 230, preferably near the juncture with concentrators 150. For example, diffusers 230 could comprise a small volume of small, imbedded light scattering bubbles or beads. The nominal size and refractive index of these scattering spheres would be chosen to encourage somewhat broad forward or side scattering but minimal backscattering. For example, these beads could be in the 3-10 μm diameter range, which places them at the low-end (smaller particle, less forward scattering) Mie scattering regime for light in the visible and near IR wavelength region. As the operational efficiency of solar cells can also depend on the uniformity (as cell efficiency depends on light intensity) of the radiation falling on the detector, then the diffusers 230 can also be used to improve the incident light uniformity. It should be understood that diffusers 230 might also be used in the other design concepts for the solar collector 100 described in the present invention.

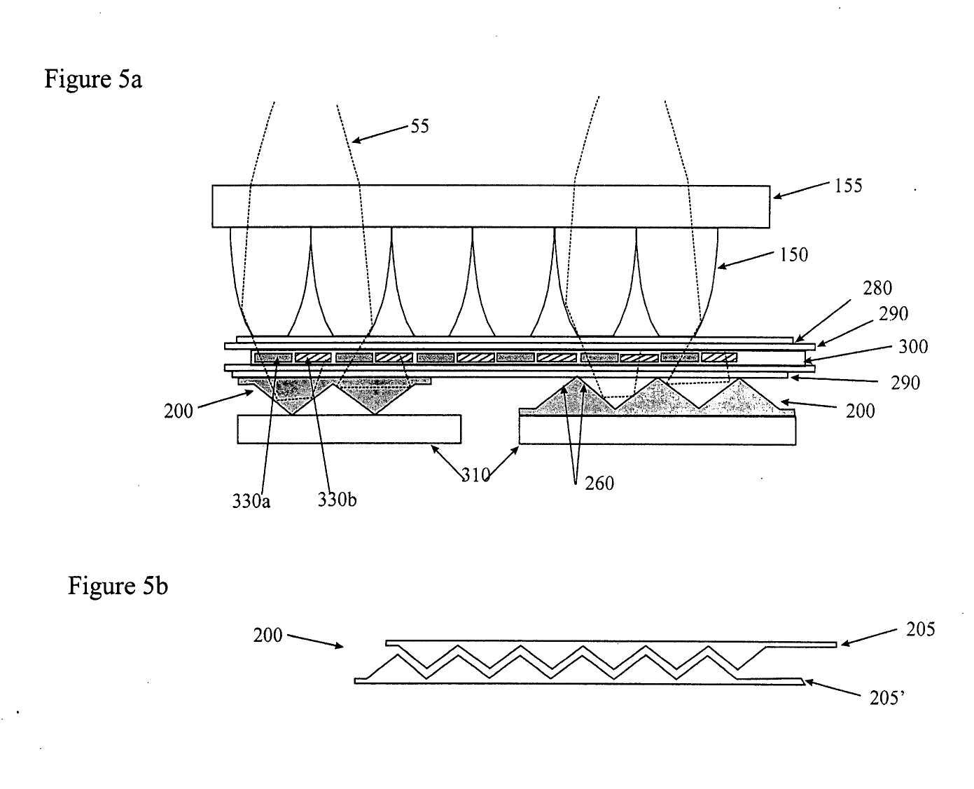

In general, the solar collection assemblies 100 of the present invention have been described as comprising cylindrical non-imaging concentrators, such as CPCs or a θin/θout concentrators. However, other optical elements, such as lenses or tapered light guides can be used, particularly as the concentrators used in the present invention may not be designed for maximal (or even high) light concentration. As an example, FIG. 6 depicts a solar collection assembly 100 in which the concentrators are cylinder lenses 160. It is noted that such an array of cylindrical lenslets is also sometimes referred to as a lenticular lens array. FIG. 7b, on the other hand, depicts a case where concentrators 150 are tapered light guides (or cones).

It should be understood that solar collection assemblies 100 could also comprise other useful thin film layers. As an example, FIG. 5c depicts concentrator substrate 155 with an overcoat blocking layer 270 provided on input surface 157. Blocking layer 270, as an example, can be a UV rejection filter, which absorbs or reflects incident UV light. While UV light is high energy, and therefore desirable to collect, UV light often degrades optical materials, and particular polymers and plastics. In particular, as high energy UV or low blue light (<420 nm, for example) can degrade or age polymers/plastics that could be used to make the concentrators 150, prisms 210, and other optical structures, as well as the detector sites 330, it can be important to block this light. As the solar radiations in the 350-420 nm band is significant, the designs should preferably accept this light. Also as it may also be important to seal or shield the detector sites from moisture or gases, both internal and external barrier layers 290, which can be impermeable polymer (such as mylar or polyurethane) membranes or films can be used, as shown in FIG. 5c. Again, numerous intervening adhesive layers (280) may be utilized in the device of FIG. 5c, and in the other device concept drawings, but these layers are generally not shown for illustrative simplicity.

Although the solar collection assemblies 100 of the present invention have been described as employing detector sites or pixels 330, the functionality is not the same as the common optical detector array, such as CCD or CMOS sensor, used for imaging. In this case, the goal is to collect and convert the solar energy as efficiently as possible, and optical crosstalk of light from one concentrator 150 to the detector sites 330 underlying and adjacent concentrator 150 can be acceptable. This possibility is illustrated in FIG. 3a, where light collected by a given concentrator (150b) illuminates multiple detector sites 330b. In the case that the illuminating light falling on a detector site (such as 330b) associated with another concentrator (150a) has the proper spectral bandwidth for that site, then little is lost. However, if this crosstalk illuminating spectra is mismatched with the detector site it illuminates, then efficiency is reduced. This can occur in part because of the wide range of angles directed into a solar collection assembly 100 over the course of a day. Light can emerge from the output portion of a concentrator 150 at angle that is extreme relative to the structure of micro-prisms 205 and spectral filters 250, such that a significant portion of this light leaks into the area underneath an adjacent concentrator with potentially a shifted spectra. The thickness of any intervening layer (such as prism array substrate 205 shown in FIG. 3a) between concentrators 150 and micro-prisms 210 can increase the crosstalk effect and the resulting efficiency loss.

As another approach, the concept for solar collection assembly 100 can be structured to have detector sites 330 elongate in a direction nominally parallel to the direction of motion of the sun 60, which is the X (East-West) direction depicted in FIG. 1. In that case, even as the sun progresses and the angles of solar light incidence progress through their extremes of acceptance (for example from +30° to 0° (noon) to −30°), the incident light can fall onto the elongate detector sites 330 with less concern for crosstalk. The detector sites 330 can still be provided with a spectrally tuned spatial pattern of elongate regions. However, in this case, the spectrally tuned detector sites 330a, 330b, etc., would be offset in the Z direction. Solar collection assembly 100 would then have spectral filtering 250 that provides offset spectra in the Z direction. Thus, the spectral splitting is nominally orthogonal with the direction of solar motion in the sky (East-West), while the pattern of elongate detector sites is parallel to the solar motion. In some respects, this can be an easier approach then the prior approaches, as the spectral filtering is happening in a direction where the angular input is both small (0.266° half angle) and comparatively static in direction. Of course, the angle of incidence changes with latitude, and then further with seasonal changes. Allowing for seasonal changes, the angular acceptance needs to be larger (such as ±10° or ±20°), or the solar collection assembly could be adjusted for tilt seasonally, or some combination thereof.

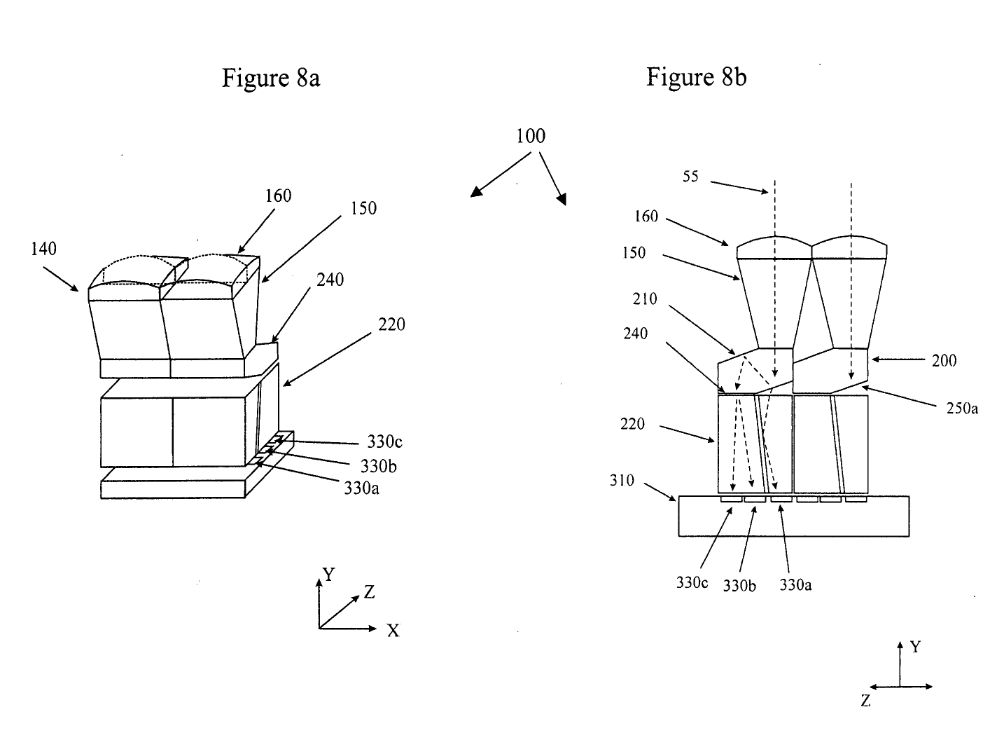

The optical structures of concentrators (150), micro-prisms (210), and detector sites (330) previously described could be used to distribute patterned light in the Z-direction. However, an alternate exemplary concept is shown in FIGS. 8a and 8b, in which the prisms 210 of micro-prism array 200 are arranged to create a series of beams in the Z-direction. Specifically, as shown in FIG. 8b, incident light 55 enters an exemplary two-stage or combination concentrator, comprising a lens 160 and a tapered bar concentrator 150. The incident light 55 then enters a micro-prism 210 corresponding to a particular two-stage concentrator. As depicted, this light encounters a first spectral filter 250a, resulting in a first light beam with spectral bandwidth Δλ₁ which is transmitted through filter 250 and integrator 220, to fall on detector site 330a of detector array 300. For the illustrated micro-prisms 210, a second light beam is reflected from spectral filter 250a, whereupon, this light beam reflects (preferably by TIR) within micro-prism 210, and falls onto a potential second spectral filter. As is shown in FIG. 8b, two light beams then enter integrator 220 and fall onto a detector sites 330b and 330c, which nominally photo-convert light of spectral bands Δλ₂ and Δλ₃ respectively.

As was previously noted, the spectral filters 250 can comprise various means including dichroic coatings and sub-wavelength optical structures. However, other approaches can be used to separate the incoming light into spectral bands for subsequent absorption and photo-conversion. For example, light dispersive optics, such as refracting prisms or diffraction gratings, could be used either individually or in combination. The virtue of dispersing or refracting prisms is that the light spectra can be spread out without overlap. However, the chromatic dispersion depends on both the dispersive properties of the material and the size of the prism. Although the dispersive properties of transparent polymer materials (such as PET & polystyrene) can be reasonably high (Δn˜0.07 over 400-1100 nm), the polymer selection will then be limited, which may impact device manufacturing, flexibility, solar exposure lifetime, or other properties. The dependence on prism size may also be limiting considering that a sheet like structure is desired.

In the case of diffraction gratings, the chromatic dispersion principally depends on the grating pitch, the incident wavelengths, the incident angle, and the diffraction order (m), but not on material properties. Additionally, as a diffraction grating, whether an amplitude or a phase grating, is constructed from low profile features which can be produced by high-volume manufacturing techniques (such as replication molding, extrusion, photo-lithographic printing, inkjet or laser thermal printing, etc . . . ), the use of a diffraction grating as a spectral filter/dispersing element in the solar collection system 100 of the present invention may be appropriate. However, care may be required, as light from one diffractive order partially overlaps with light from the adjacent diffractive orders (that is, a limited free spectral range).

With these considerations, the solar collection system 100 of FIGS. 8a and 8b has as its second spectral filter a diffraction grating 240. For example, a combination of visible and near infrared light could enter a concentrator 150 and then encounter a first spectral filter 250a. The visible (and perhaps UV) light could be transmitted through a bandpass filter 250a to become the first spectral band Δλ₁ which will encounter detector site 330a. The reflected light is routed through micro-prism 210 to encounter a possible second spectral filter, which in this case, is diffraction grating 240. While diffraction grating 240 can be an amplitude grating or a phase grating, in this configuration it is preferably a transmissive blazed phase grating (see FIG. 4e), which has its grating surfaces angled to bias light into the m=1 diffraction order. For example, according to the well known grating equation, in which d is the grating groove pitch, α is the angle of incidence and β is the angle of diffraction,

d(sin α±sin β)=mλ (1)

a diffraction grating 240 can have 5.4 μm pitch (d) features (or 185 lines/mm), such that 750 nm light diffracts at ˜8.0°, 1100 nm light diffracts at ˜11.75°, and 1500 nm light diffracts at ˜16.1°, for an angular spread of Δθ˜8.0°. Thus, while detector site 330a receives “visible” light (Δλ₁<750 nm), detector site 330b can receive very very near IR light (Δλ₂˜750-1100 nm) and detector site 330c can receive near IR light (Δλ₃˜1100-1500 nm). The diffraction grating is preferably used as a spectral filter for the IR light, rather the visible light, as the crosstalk or leakage between diffractive orders in the visible spectrum is significantly greater, and thus more limiting for this application.

In general, a blazed diffraction grating (see FIG. 4e) could be particularly useful as an infrared spectral filtering means for a multi-spectral array solar collector, as a wide angular spread and a wide spectral range can be handled simultaneously without spectral overlap (wide free spectral range). The design could be a trade-off of angular spread versus grating efficiency, relative to minimizing crosstalk between orders. To minimize crosstalk, the design parameters (such as grating pitch, blaze angle θ_{b}, blaze profile, blaze wavelength λ_{b}) need to be chosen carefully. Maximum efficiency into the first order (m=1) is achieved if the blazed grating satisfies the Littrow condition, in which α=b at the blaze wavelength λ_{b}, such that

λ_{b}=2*d*sin(θ_{b})/m (2)

For example, if the blaze wavelength is defined as λ_{b}˜900 nm, and the pitch d=5.4 μm, the blaze angle for the m=1 order is θ_{b}˜4.8°, and the efficiency could be >70% into the m=1 order over the 750-1500 nm wavelength range. In this case, as the blaze angle is low, a high diffraction efficiency into the first order can be anticipated. As the blaze angle increases, diffraction anomalies appear, which can degrade or enhance the effective grating efficiency. For example, it is known that diffraction anomalies are suppressed for blaze angles of θ_{b}˜15-22°, resulting in an improvement in the diffraction efficiency over a larger range of conditions. As an example, if the grating pitch was decreased (d˜2 μm), then the blaze angle for a 900 nm blaze wavelength would be increased to θ_{b}˜16°, resulting in both a larger angular spread Δθ˜25° and a higher expected light efficiency (˜90%) into the m=1 order for the target 750-1500 nm wavelength range.

Crosstalk can also be minimized by designing the transitions of the spectral filters to match with the “holes” in the solar spectrum. For example the “visible” light redirected by filter 250a could have a transition at ˜740 nm, corresponding to one of the significant atmospheric absorption bands. The diffraction grating spectral filter 240 might then disperse light over a wider angular range, because there would be minimal crosstalk concern at ˜740 nm. As another example, diffraction grating 240 could be optimized to accept and disperse light over a red-shifted spectral range (as compared to the prior 750-1500 nm example) spanning ˜675-1350 nm, while spectral filter 250a would be designed to transmit light <675 nm and reflect light >675 nm. This approach acknowledges that the radiation spectrum from ˜1.38-1.5 μm has been largely removed by an atmospheric absorption band. Although there is some light in the 1.5-1.8 μm band, device performance in this regime could be sacrificed for superior performance elsewhere.

It should be understood that other physical configurations for the prisms 210 and the gratings 240 could be used. In particular, a reflective blazed diffraction grating, which is a more commonly manufactured optical element than a transmissive blazed diffraction grating, could be used instead. Diffraction grating 240 could be molded into a prism surface (which may be tilted), while spectral filter 250a could be a thin film coating or a sub-wavelength patterned nano-structure, which again could be molded into the prism surface. It is also possible that a first spectral filter could be a diffraction grating that would work in cascading fashion with a second diffraction grating (240).

In FIGS. 8a and 8b, integrator 220 is shown as having a bifurcated structure, with an internal air surface, which helps to contain and direct light Δλ₁ by TIR to detector site 330a. Integrator 220 also provides a physical offset spacing for the light of the Δλ_{2,3} spectral bands to propagate away from one another and to the appropriate detector 33b or 330c. The concentrator 150, is depicted as a ID tapered light guide, with a taper or narrowing in the YZ plane. This tapering is provided principally to neck down the structure from a lens 160 to the input face of a micro-prism 210. However, concentrator 150 could also be tapered in the XY plane.

The lenses 160 of the solar collector system 100 of FIGS. 8a and 8b are shown as two-dimensional lenslets (optical power in both the XY and YZ planes). However, there are various possibilities. The lensing or focusing required in the two directions could be very different. For example, in the X-direction (East-West), the detector sites 330a,b,c could extend in a parallel linear arrangement under multiple concentrators 150. In that case, lenses with power in the XY plane may not be needed. However, solar light acceptance (during the day) and power density considerations suggest having XY lens power is preferable. In the YZ plane, the entering beam is basically collimated, and the beam direction changes slowly with the seasons of the year. As a result, there may not be any curvature in the YZ plane, and concentrator system 100 may have extended cylindrical (anamorphic) concentrators with XY plane power only, much as depicted in FIG. 1. However, YZ plane optical power could be useful to fit the light beams within the diffraction grating 240 and respective detector sites 330a,b,c (and also to accommodate seasonal changes). Thus, as another alternative, separate crossed (nominally orthogonal) cylindrical lenslet arrays could be used in place of an array of lenslets with optical power in two dimensions. As a further alternative to tilting the solar collection system 100 to compensate for seasonal changes in the direction of incidence in the YZ plane, the integrated sheet lenslet array of lenslets having YZ plane power could shifted laterally to re-direct the light and increase conversion efficiency. In a sense, the YZ plane cylindrical lenslet array then operates as a beam steering device that simultaneously re-directs a multitude of beams. Depending on the design details and latitude, only 3 positions may be needed to span and correct for the seasonal variations.

The solar collector 100 could also utilize a component for photo-conversion. For example, an initial spectral beamsplitter could be provided to separate a first spectral range comprising the UV-low blue radiation (for example 300-450 nm) from the rest of the spectrum. A second spectral beamsplitter could be used to separate a second spectral range (for example 450-700 nm) from a third spectral range (>700 nm, the infrared). The radiation of the second and third spectral ranges could be directed to detector sites 330 with spectral responses optimized for the respective incident radiation. The light of the first spectral range could then encounter a photo-conversion layer that would absorb the incident UV-low blue light and then up-convert to produce higher wavelength light, for example, in the second spectral range. This light could then be incident on detector sites 330 which are optimized to the second spectral range. For example, many organic materials, such as collagen and organic dyes, are known to absorb UV light and fluoresce at higher wavelengths. More generally, an optically stimulated organic active region using a small-molecular weight organic host-dopant combination (similar to OLEDs) could be used to produce the higher wavelength light. Alternately, the photo-conversion layer could use quantum dot nano-crystals to produce higher wavelength emission spectra. Of course, the quantum efficiency of the photo-conversion layer should be high to justify this extra-process. Additionally the emitted light must be efficiently directed towards the appropriate detector site 330. If the photo-conversion layer has a low absorbance to light in the second spectral range, it may not be necessary to provide the described first spectral beamsplitter to separate the exemplary first and second spectrums. A photo-conversion layer could also down convert higher wavelength excitation light into lower wavelength emission light.

It should be understood that the solar collector 100 of the present invention does not pre-suppose the use of a particular solar cell technology. As noted previously, there are many competing thin film solar cell technologies, including crystalline thin films, amorphous silicon films (a-Si), and nano-structured composites films, which include nano-crystalline silicon thin films (nc-Si), dye sensitized nano-crystalline thin films (Gratzel solar cell), the organic polymer cell, and the nanoparticle/organic polymer composite solar cell. These various technologies may be used individually or in combination. For example, in the case of the quantum dot based solar cells, detector sites 330a,b with different spectral responses may comprise nano-crystalline quantum dot layers with different characteristics. The size, size distribution, composition, and shape of the quantum dots, as well as the layer thickness, in detector sites 330a may be different than in detector sites 330b, in order to optimize the spectral responses appropriately. The solar cell layers comprising the detector sites 330 may also be provided with patterned light trapping structures, much as described in the prior art Wettling '297 and Zaidi '462 patents.

The solar collector 100 of the present invention has been described thus far as a conversion device for solar energy. Although the present invention has been particularly described as being appropriate for thin film solar cells, the design concepts could also be applied to larger scale devices, such as the semiconductor wafer type devices. Of course, it should be understood that solar collector/optical detector 100 could convert ambient light energy from non-solar light sources, including from room or outdoor lighting. Thin solar panels have been used to power various devices, including low-end consumer electronics, such as calculators. As the present invention anticipates a device that specifically employs thin film optical and electronic structures, this device could be integrated with other thin film devices or components. For example, the thin film solar collection system 100 could be combined with a thin film lithium polymer battery and a thin film display (using for example, organic light emitting diode (OLED), polymer-LED (PLED), or thin film electroluminescent (TFEL) technologies), to provide a thin solar powered display device. Unfortunately, as the solar collector, battery, and display components likely use different material sets, processing equipment and requirements, and internal structures, it is likely very difficult to fabricate the three components in adjacent proximity on one contiguous thin film substrate. However, the three individual thin film structures could likely be integrated together in some useful way.

It should be understood that the various figures provided to illustrate the concepts of the present invention for a solar cell with integrated concentrating and spectral beam splitting optics and spectrally sensitized patterned photo-sites are not engineering drawings, and therefore are not necessarily to scale. The various elements in the drawings are not necessarily in scale relative to each other.

The invention has been described in detail with particular reference to a presently preferred embodiment, but it will be understood that variations and modifications can be effected within the scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein. For example, solar collection system 100 can be further equipped with thermal control means (either active or passive) to maintain the operational temperature within the nominal target range.

### Parts List

50 Light
55 raypaths
60 sun
100 Integrated optical detector; solar collection assembly
140 concentrator array
150, 150a, 150b Optical concentrator
155 Concentrator substrate
157 input surface
158 inner surface
160 Lens
180 First registration feature
185 Second registration feature
190 Intermediate layer (adhesive)
200 Micro-prism assembly
205, 205′ Prism substrate
210, 210a, 210b Micro-prism
220 integrator
230 diffuser
240 diffraction grating
250, 250a, 250b spectral filter
260 reflecting surface
270 blocking filter
280 adhesive
290 barrier layers
300 Photo receptive detector array
310 Detector substrate
320 Circuit
330, 330a, 330b, 330c Pixel (or detector site)
340 second detector array
350, 350a, 350b, 350c Pixel (detector site)

1. An integrated optical detector assembly comprising;
a) an optical concentrator for receiving and concentrating incident light;
b) a spectral splitting assembly for splitting said incident light into multiple beams of light, each with a different nominal spectral bandwidth; and
c) an array of optical detector sites wherein each of said detector sites has a nominal spectral response and wherein said detector sites are spatially arranged to provide an arrangement of said detector sites which are spatially variant relative to said nominal spectral responses;
wherein each of said detector sites nominally receives one of said multiple beams of light, such that the spectral bandwidths of light which are directed to said detector sites nominally match said nominal spectral responses of said detector sites; and
wherein said optical concentrator, said spectral splitting assembly, and said array of optical detector sites are replicated in an array-like fashion to form said integrated optical detector assembly.

2. An integrated optical detector assembly according to claim 1 wherein said spectral splitting assembly comprises a micro-prism structure with one or more spectral filters.

3. An integrated optical detector assembly according to claim 2 wherein multiple spectral filters are used in combination in cascading fashion.

4. An integrated optical detector assembly according to claim 2 wherein said spectral filters comprise a first spectral filter that separates the visible light from the infrared light and a second spectral filter that is a diffraction grating that splits the infrared light to create a spatially variant pattern of said infrared light.

5. An integrated optical detector assembly according to claim 2 wherein said spectral filters comprise at least a blazed diffraction grating.

6. An integrated optical detector assembly according to claim 1 wherein said spectral splitting assembly comprises one or more spectral filters arranged to provide said multiple beams of light so that multiple beams of light are spatially separate and spectrally distinct.

7. An integrated optical detector assembly according to claim 1 wherein said spectral splitting assembly comprises one or more spectral filters, which are provided as at least one of the following; a dichroic coating, a sub-wavelength patterned structure, a diffraction grating, or a refracting prism.

8. An integrated optical detector assembly according to claim 1 wherein said spectral splitting assembly splits said light beams in a direction that is nominally parallel with the direction of daily solar motion across the sky, while said detector sites are spatially arranged in a direction that is nominally orthogonal to the direction of solar motion across the sky.

9. An integrated optical detector assembly according to claim 1 wherein said spectral splitting assembly splits said light beams in a direction that is nominally orthogonal with the direction of daily solar motion across the sky, while said detector sites are spatially arranged in a direction that is nominally parallel to the direction of solar motion across the sky.

10. An integrated optical detector assembly according to claim 1 wherein circuitry is provided within a detector substrate to collect and transfer the photo-generated electrons provided as a result of the energy conversion of said incident light.

11. An integrated optical detector assembly according to claim 1 wherein said optical concentrator comprises at least one of a lens, a tapered light guide, a compound parabolic concentrator, or a θin-θout concentrator.

12. An integrated optical detector assembly according to claim 11 wherein said optical concentrator comprises a cylindrical optical element.

13. An integrated optical detector assembly according to claim 1 wherein said spectral splitting assembly further comprises an optical diffuser.

14. An integrated optical detector assembly according to claim 1 wherein said array of detector sites comprises a first array located in a plane and a second array located in a second plane parallel to said first plane.

15. An integrated optical detector assembly according to claim 1 wherein said assembly is a multi-layer device having a first plane with said array of detector sites and having a second plane with additional detector sites.

16. An integrated optical detector assembly according to claim 1 wherein barrier layers or coatings are provided to control the penetration of moisture, humidity, or ultraviolet radiation, either individually, or in combination, into said optical detector assembly.

17. A thin film solar collection system comprising;
a) an array of optical concentrators, formed into one or more sheets, for receiving and concentrating incident solar radiation;
b) an array of spectral splitting structures formed into one or more sheets, wherein each of said spectral splitting structures comprises a prism structure for directing light and one or more spectral filters, which in combination separate said solar radiation into a multitude of spectrally separate light beams; and
c) an array of detector sites formed in a sheet like structure, wherein said array comprises a spatially variant pattern of said detector sites, in which the nominal spectral response of said detector sites varies from one detector site to another;
wherein an integrated sheet-like structure is formed in which said arrays are aligned such that a given optical concentrator is associated with a given spectral splitting structure and a given array of detector sites; and
wherein said given optical concentrator collects a portion of said incident solar radiation and directs it into said given spectral splitting structure, from which said multitude of spectrally separate light beams are directed to said given array of detector sites, such that the spectral bandwidths of light which are directed to said detector sites nominally match said nominal spectral responses of said detector sites.

18. A solar collection system according to claim 17 wherein said spectral filters comprise at least one of the following; a dichroic coating, a sub-wavelength patterned structure, a diffraction grating, or a refracting prism.

19. A solar collection system according to claim 17 wherein multiple spectral filters are used in combination in cascading fashion.

20. A solar collection system according to claim 17 wherein said spectral filters comprise a first spectral filter that separates the visible light from the infrared light and a second spectral filter that is a diffraction grating that splits the infrared light to create a spatially variant pattern of said infrared light.

21. A solar collection system according to claim 17 wherein said spectral filters comprise at least a blazed diffraction grating.

22. A solar collection system according to claim 17 wherein said spectral splitting structure splits said light beams in a direction that is nominally parallel with the direction of daily solar motion across the sky, while said detector sites are spatially arranged in a direction that is nominally orthogonal to the direction of solar motion across the sky.

23. A solar collection system according to claim 17 wherein said spectral splitting structure splits said light beams in a direction that is nominally orthogonal with the direction of daily solar motion across the sky, while said detector sites are spatially arranged in a direction that is nominally parallel to the direction of solar motion across the sky.

24. A solar collection system according to claim 17 wherein circuitry is provided within a detector substrate to collect and transfer the photo-generated electrons provided as a result of the energy conversion of said incident light.

25. A solar collection system according to claim 17 wherein said optical concentrator comprises at least one of a lens, a tapered light guide, a compound parabolic concentrator, or a θin-θout concentrator.

26. A solar collection system according to claim 17 wherein a first of said sheets comprises a lens array, and a second of said sheets comprises a light guide, wherein a given lens nominally corresponds to a given light guide.

27. A solar collection system according to claim 26 wherein said first sheet comprising a lens array can be adjusted laterally, such that the position of said lens is changed relative to the position of said corresponding light guide.

28. A solar collection system according to claim 17 wherein said sheets include alignment features to provided internal registration of said sheets during the assembly and use of said integrated sheet-like structure.

29. A solar collection system according to claim 17 wherein said spectral splitting assembly further comprises an optical diffuser.

30. A solar collection system according to claim 17 wherein said array of detector sites comprises a first array located in a plane and a second array located in a second plane parallel to said first plane.

31. A solar collection system according to claim 17 wherein barrier layers are provided to control the penetration of moisture, humidity or ultraviolet radiation, either individually, or in combination, into said solar collection system.

32. A thin film solar collection system comprising;
a) a sheet-like array of optical concentrators for receiving and concentrating incident solar radiation;
b) a sheet-like array of spectral splitting structures, wherein each of said spectral splitting structures comprises a prism structure for directing light and one or more spectral filters, which in combination separate said solar radiation into a multitude of spectrally separate light beams; and
c) a sheet-like array of detector sites, wherein said array comprises a spatially variant pattern array of said detector sites, in which the nominal spectral response of said detector sites varies from one detector site to another;
wherein an integrated sheet-like structure is formed in which said sheet-like arrays are co-aligned such that a given optical concentrator is associated with a given spectral splitting structure and a given array of detector sites; and
wherein said given optical concentrator collects a portion of said incident solar radiation and directs it into said given spectral splitting structure, from which said multitude of spectrally separate light beams are directed to said given array of detector sites, such that the spectral bandwidths of light which are provided to said detector sites nominally match said nominal spectral responses of said detector sites.

33. A solar collection system according to claim 32 wherein said spectral filters comprise at least one of the following; a dichroic coating, a sub-wavelength patterned structure, a diffraction grating, or a refracting prism.

34. A solar collection system according to claim 32 wherein said spectral splitting structure splits said light beams in a direction that is nominally orthogonal with the direction of daily solar motion across the sky, while said detector sites are spatially arranged in a direction that is nominally parallel to the direction of solar motion across the sky.

35. A solar collection system according to claim 32 wherein said spectral filters comprise a first spectral filter that separates the visible light from the infrared light and a second spectral filter that is a diffraction grating that splits the infrared light to create a spatially variant pattern of said infrared light.

36. A thin film solar collection system comprising an array of photo-conversion sub-systems comprising an integrated sheet-like structure, wherein each of said sub-systems comprises an optical concentrator for receiving incident solar radiation, a spectral splitting structure, and an array of detector sites;
wherein each of said spectral splitting structures separate said incident solar radiation into a multitude of spectrally separate light beams;
wherein each of said arrays of optical detector sites comprises a series of detector sites which are arranged to provide a spatially variant pattern of nominal spectral responses across said series of detector sites; and
wherein each of said detector sites nominally receives one of said multitude beams of light, such that the incident light spectra which are provided to said detector sites nominally match said nominal spectral responses of said detector sites.

37. A solar collection system according to claim 36 wherein said spectral splitting structure comprises a micro-prism structure with one or more spectral filters.

38. A solar collection system according to claim 36 wherein said spectral splitting structure comprises one or more spectral filters, which are provided as at least one of the following; a dichroic coating, a sub-wavelength patterned structure, a diffraction grating, or a refracting prism.

39. A solar collection system according to claim 36 wherein said spectral splitting structure splits said light beams in a direction that is nominally orthogonal with the direction of daily solar motion across the sky, while said detector sites are spatially arranged in a direction that is nominally parallel to the direction of solar motion across the sky.

40. A solar collection system according to claim 36 wherein said spectral filters comprise a first spectral filter that separates the visible light from the infrared light and a second spectral filter that is a diffraction grating that splits the infrared light to create a spatially variant pattern of said infrared light.

41. A solar energy collection system comprising;
a) an array of optical concentrators, formed into one or more sheets, for receiving and concentrating incident solar radiation;
b) an array of spectral splitting structures formed into one or more sheets, wherein each of said spectral splitting structures comprises one or more spectral filters which separate said solar radiation into a multitude of spectrally separate light beams;
c) an array of detector sites formed in a sheet like structure, wherein said array comprises a pattern of said detector sites, in which each of said detector sites has a spatially variant pattern of nominal spectral responses across a width of said detector site;
wherein an integrated sheet-like structure is formed in which said arrays are aligned such that a given optical concentrator is associated with a given spectral splitting structure and a given detector site; and
wherein said detector site nominally receives said multitude beams of light, such that the incident light spectra which are provided to said detector site nominally match to said spatially variant pattern of nominal spectral responses of said detector site.

42. A solar energy collection system according to claim 41 wherein said spectral filters comprise at least one of the following; a dichroic coating, a sub-wavelength patterned structure, a diffraction grating, or a refracting prism.

43. A solar energy collection system according to claim 41 wherein said spectral splitting structure splits said light beams in a direction that is nominally orthogonal with the direction of daily solar motion across the sky, while said detector sites are spatially arranged in a direction that is nominally parallel to the direction of solar motion across the sky.

44. A solar energy collection system according to claim 41 wherein said spectral filters comprise a first spectral filter that separates the visible light from the infrared light and a second spectral filter that is a diffraction grating that splits the infrared light to create a spatially variant pattern of said infrared light.

45. A method for detecting and converting incident light into photo-generated electrical energy, comprising collecting said incident radiation with an array of concentrators, splitting the light collected by each of said concentrators into two or more spectral components by spatially separating the two or more components, and directing each of the spatially separated components to an associated photo-sensitive detector having a spectral response tailored for the component received.
